(19) United States
(12) Patent Application Publication
(10) Pub. No.: US 2022/0219821 A1
(43) Pub. Date: Jul. 14, 2022

(54) Inflatable Aerodynamic Cargo Container

(71) Applicant: Bell Textron Inc., Fort Worth, TX (US)

(72) Inventor: Justin A. Rivera, Grapevine, TX (US)

(73) Assignee: Bell Textron Inc., Fort Worth, TX (US)

(21) Appl. No.: 17/145,884

(22) Filed: Jan. 11, 2021

(51) Int. Cl. B64D 9/00; B64D 1/10

(52) U.S. Cl. CPC B64D 9/003; B64D 1/10

(57) ABSTRACT

An inflatable pod assembly for an aircraft includes an expandable exoskeleton. The expandable exoskeleton defines a leading edge and a trailing edge of the inflatable pod assembly, and the expandable exoskeleton includes first and second portions selectively attachable to each other. The inflatable pod assembly also includes an internal cargo area configured to receive cargo, and the first and second portions are configured to selectively enclose the internal cargo area when the first and second portions are attached to each other. The inflatable pod assembly further includes an internal inflation chamber configured to selectively receive an inflation fluid for expanding the exoskeleton to thereby transition the inflatable pod assembly from a deflated state to an inflated state.

### TECHNICAL FIELD

The present disclosure is directed to an aerodynamic cargo container for an aircraft and, more particularly, to an inflatable aerodynamic cargo container for an aircraft.

### BACKGROUND OF THE INVENTION

Aircraft, including vertical takeoff and landing (VTOL) aircraft such as helicopters, tiltrotor aircraft, and tiltwing aircraft, are commonly used to transport cargo from one geographical location to another. In some instances, cargo may be loaded into a pod assembly which is selectively attachable to an exterior of the aircraft, such as an underside of a helicopter, to facilitate transportation of the cargo via the aircraft.

### BRIEF SUMMARY OF THE INVENTION

In a first aspect, the present disclosure is directed to an inflatable pod assembly for an aircraft. The inflatable pod assembly includes (a) an expandable exoskeleton, wherein the expandable exoskeleton defines a leading edge and a trailing edge of the inflatable pod assembly, wherein the expandable exoskeleton includes first and second portions selectively attachable to each other; (b) an internal cargo area configured to receive cargo, wherein the first and second portions are configured to selectively enclose the internal cargo area when the first and second portions are attached to each other; and (c) an internal inflation chamber configured to selectively receive an inflation fluid for expanding the exoskeleton to thereby transition the inflatable pod assembly from a deflated state to an inflated state. In some embodiments, the internal inflation chamber is defined by the internal cargo area. In other embodiments, the internal inflation chamber is defined by a pocket fluidly isolated from the internal cargo area.

In some embodiments, the inflatable pod assembly further includes at least one coupling mechanism configured to selectively attach the first and second portions of the expandable exoskeleton to each other to thereby enclose the internal cargo area. The at least one coupling mechanism may be configured to provide a fluid-tight seal between the first and second portions of the expandable exoskeleton when the first and second portions are attached to each other. In addition or alternatively, the at least one coupling mechanism may include a zipper. In some embodiments, the expandable exoskeleton includes a flexible material. For example, the flexible material may include nylon. In some embodiments, the inflatable pod assembly further includes at least one partition positioned in the internal cargo area and selectively attachable to the expandable exoskeleton for dividing the internal cargo area into a plurality of cargo area compartments. In addition or alternatively, the inflatable pod assembly may further include at least one attachment device configured to couple to a receiving assembly of the aircraft.

In some embodiments, the first portion includes a forward exoskeleton portion, and the second portion includes an aft exoskeleton portion separable from the forward exoskeleton portion. In this regard, the inflatable pod assembly may further include an intermediate frame portion, wherein the at least one coupling mechanism includes a forward coupling mechanism and an aft coupling mechanism configured to selectively attach the forward and aft exoskeleton portions to the intermediate frame portion, respectively, for operatively attaching the forward and aft exoskeleton portions to each other. For example, the intermediate frame portion may include a rigid material. In other embodiments, the trailing edge is bifurcated, wherein the first portion includes an upper trailing edge portion, wherein the second portion includes a lower trailing edge portion. In this regard, the expandable exoskeleton may include a forward exoskeleton portion and an aft exoskeleton portion integrally formed together as a unitary piece.

In a second aspect, the present disclosure is directed to an aircraft including (a) an aircraft body; and (b) an inflatable pod assembly selectively attached to the aircraft body, wherein the inflatable pod assembly includes: (i) an expandable exoskeleton, and (ii) an internal cargo area defined within the expandable exoskeleton, wherein the internal cargo area is configured to receive cargo. In some embodiments, the inflatable pod assembly further includes an internal inflation chamber configured to selectively receive an inflation fluid for expanding the exoskeleton to thereby transition the inflatable pod assembly from a deflated state to an inflated state. In addition or alternatively, the inflatable pod assembly may be selectively attached to an exterior of the aircraft body.

In a third aspect, the present disclosure is directed to a method of transporting cargo. The method includes (a) loading the cargo into an internal cargo area of an inflatable pod assembly; (b) directing an inflation fluid into an internal inflation chamber of the inflatable pod assembly to transition the inflatable pod assembly from a deflated state to an inflated state; (c) selectively attaching the inflatable pod assembly to an aircraft body of an aircraft; and (d) conducting a flight operation via the aircraft while the inflatable pod assembly is selectively attached to the aircraft body and in the inflated state. In some embodiments, the method further includes (a) jettisoning the inflatable pod assembly from the aircraft body over a body of water; and (b) floating the inflatable pod assembly atop the body of water via the inflation fluid within the internal inflation chamber of the inflatable pod assembly.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a perspective view of an aircraft including an exemplary pod assembly, showing the pod assembly in an inflated state;

FIG. 2 is a perspective view of the pod assembly of FIG. 1;

FIG. 3 is a cross-sectional view of the pod assembly of FIG. 1, taken along section line 3-3 in FIG. 2;

FIG. 4 is a cross-sectional view of another exemplary pod assembly, showing the pod assembly in an inflated state;

FIG. 5 is a flowchart of an exemplary method of transporting cargo; and

FIG. 6 is a flowchart of an exemplary method of manufacturing a pod assembly.

### DETAILED DESCRIPTION OF THE INVENTION

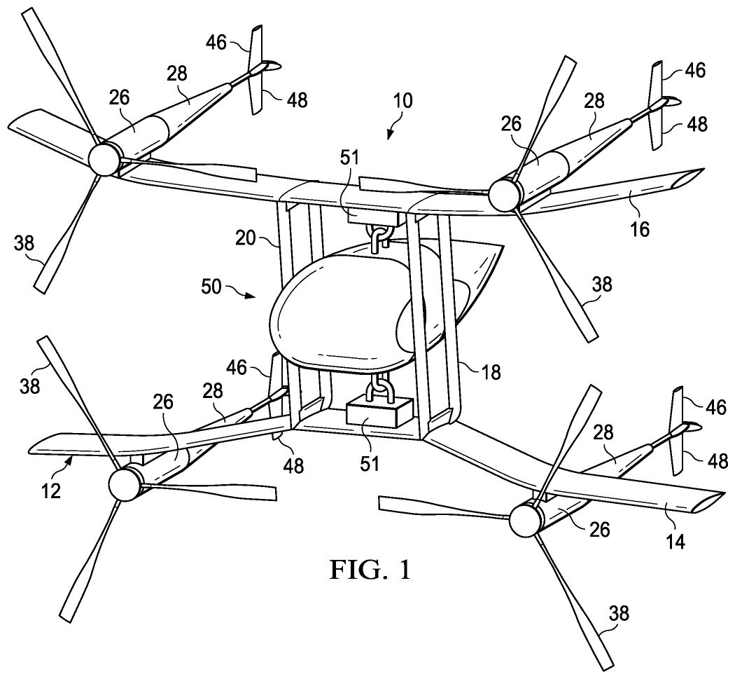

Referring now to FIG. 1, an aircraft 10 having a versatile propulsion system is depicted. In the illustrated embodiment, aircraft 10 includes an airframe 12 having wings 14, 16 each having an airfoil cross-section that generates lift responsive to the forward airspeed of aircraft 10. Extending generally perpendicularly between wings 14, 16 are truss structures depicted as pylons 18, 20. In the illustrated embodiment, the versatile propulsion system includes a plurality of independently operating propulsion assemblies 26 that are independently attachable to and detachable from airframe 12. As shown, each propulsion assembly 26 includes a nacelle 28 that houses a power source, an engine or motor, a drive system, a rotor hub, actuators and an electronics node including, for example, controllers, sensors and communications elements as well as other components suitable for use in the operation of a propulsion assembly. Each propulsion assembly 26 also includes a tail assembly 46 having an active aerosurface 48. In addition, each propulsion assembly 26 has a rotor assembly including the rotor hub having a plurality of grips such as spindle grips and a proprotor 38 depicted as having three rotor blades each of which is coupled to one of the spindle grips of the respective rotor hub such that the rotor blades are operable to rotate with the spindle grips about respective pitch change axes. These and various other components of aircraft 10 may be configured in accordance with at least some of the teachings of U.S. Pat. No. 10,618,646, entitled “Rotor Assembly Having A Ball Joint For Thrust Vectoring Capabilities,” issued Apr. 14, 2020, the disclosure of which is incorporated by reference herein.

Aircraft 10 includes a pod assembly, illustrated as cargo pod assembly 50, that is selectively attachable to and detachable from airframe 12 between pylons 18, 20. In the illustrated embodiment, wings 14, 16 each include a receiving assembly 51 for coupling with pod assembly 50. The connection between wings 14, 16 and pod assembly 50 may be a fixed connection that secures pod assembly 50 in a single location relative to airframe 12. Alternatively, pod assembly 50 may be allowed to rotate and/or translate relative to airframe 12 during ground and/or flight operations. Such a configuration may be provided in accordance with at least some of the teachings of U.S. Pat. No. 10,618,646. In any event, pod assembly 50 may be selectively coupled to and decoupled from airframe 12 to enable sequential pickup, transportation and delivery of one or more pod assemblies 50.

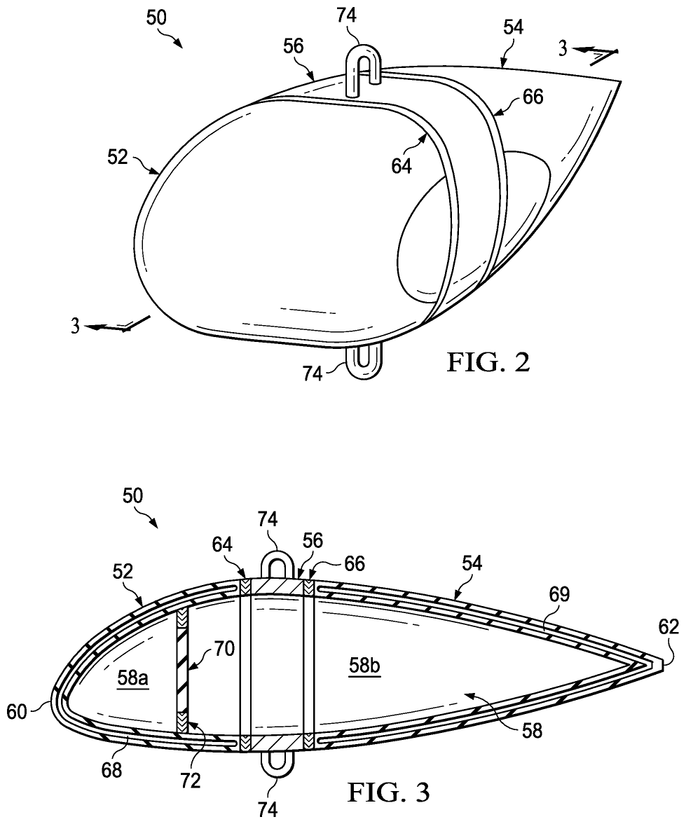

Referring now to FIGS. 2 and 3, pod assembly 50 includes a generally bulbous forward exoskeleton portion 52 and a generally tapered aft exoskeleton portion 54 operatively coupled to each other via an intermediate frame portion 56 to collectively define an internal cargo area 58. When coupled to each other in this manner, forward and aft exoskeleton portions 52, 54 provide pod assembly 50 with an aerodynamic exterior shape and define leading and trailing edges 60, 62, respectively, of pod assembly 50. In some versions, pod assembly 50 may have a length of between approximately 3 ft and approximately 4 ft, a height of approximately 1½ ft to approximately 2 ft, and a width of approximately 3 ft. However, it will be appreciated that pod assembly 50 may have any suitable dimensions based on various parameters such as the amount of cargo to be transported and the load capacity of aircraft 10, for example.

As shown, an aft face of forward exoskeleton portion 52 is selectively attachable to and detachable from a forward face of intermediate frame portion 56 by a forward coupling mechanism in the form of a forward zipper 64, and a forward face of aft exoskeleton portion 54 is likewise selectively attachable to and detachable from an aft face of intermediate frame portion 56 by an aft coupling mechanism in the form of an aft zipper 66. Thus, forward and aft zippers 64, 66 may permit selective attaching of each exoskeleton portion 52, 54 to intermediate frame portion 56 to enclose internal cargo area 58, as well as selective detaching (e.g., full or partial detaching) of one or both exoskeleton portions 52, 54 from intermediate frame portion 56 to permit access to internal cargo area 58, such as for loading cargo thereinto or unloading cargo therefrom.

In some versions, forward and aft zippers 64, 66 may be configured to provide a fluid-tight (e.g., airtight and/or watertight) seal between intermediate frame portion 56 and the respective exoskeleton portions 52, 54 such that internal cargo area 58 may be fluidly isolated from an external environment surrounding pod assembly 50 when exoskeleton portions 52, 54 are each attached to intermediate frame portion 56. Thus, forward and aft zippers 64, 66 may provide both a coupling function and a sealing function. While forward and aft zippers 64, 66 are shown in the present version, it will be appreciated that any other suitable types of coupling mechanisms may be used to selectively attach exoskeleton portions 52, 54 to intermediate frame portion 56, such as a hook-and-loop fastener (e.g., Velcro). In addition or alternatively, any other suitable types of sealing mechanisms may be used to provide a fluid-tight seal between exoskeleton portions 52, 54 and intermediate frame portion 56.

In some versions, pod assembly 50 may be at least partially inflatable. In this regard, forward and aft exoskeleton portions 52, 54 may each be constructed of a flexible, semi-rigid material having durable and UV resistant properties, such as any material known for forming emergency helicopter floats. For example, forward and aft exoskeleton portions 52, 54 may each be constructed of a synthetic polymeric textile, such as a nylon textile. Such a construction may enable forward and aft exoskeleton portions 52, 54 to selectively expand and contract. In the present version, forward and aft exoskeleton portions 52, 54 may expand and contract when coupled to intermediate frame portion 56 in response to an inflation fluid such as air or nitrogen being introduced to and removed from internal cargo area 58, respectively. For example, fluid may be introduced to internal cargo area 58 to expand forward and aft exoskeleton portions 52, 54 to define the illustrated inflated state of pod assembly 50, and fluid may be removed from internal cargo area 58 to contract forward and aft exoskeleton portions 52, 54 to define a deflated state (not shown) of pod assembly 50. In some versions, at least one fluid port (not shown) may extend through at least one of forward exoskeleton portion 52, aft exoskeleton portion 54, and/or intermediate frame portion 56 to facilitate transfer of fluid into and out of internal cargo area 58. Thus, in addition to containing cargo, internal cargo area 58 may define an internal inflation chamber of pod assembly 50.

As shown, one or both exoskeleton portions 52, 54 may also include at least one internal pocket 68, 69, respectively, fluidly isolated from internal cargo area 58 for receiving an inflation fluid such as air or nitrogen to expand exoskeleton portions 52, 54 irrespective of whether exoskeleton portions 52, 54 are coupled to each other. For example, one or both exoskeleton portions 52, 54 may include a pair of panels spaced apart from each other to define a pocket 68, 69 therebetween. In such cases, the pockets 68, 69 of exoskeleton portion(s) 52, 54 may be filled with fluid in addition to or instead of internal cargo area 58 to thereby inflate a periphery of pod assembly 50. Thus, pockets 68, 69 may each define an internal inflation chamber of pod assembly 50. Such pockets 68, 69 may be provided in any suitable number and arrangement. In some versions, filling such pockets 68, 69 of exoskeleton portion(s) 52, 54 may assist with avoiding deflation of pod assembly 50 when either exoskeleton portion 52, 54 is fully or partially uncoupled from intermediate frame portion 56 (e.g., to access internal cargo area 58 for loading or unloading cargo), thereby placing internal cargo area 58 in fluid communication with the external environment. Alternatively, pockets 68, 69 may be omitted (e.g., exoskeleton portions 52, 54 may each be formed as a singular panel), such that internal cargo area 58 may provide the sole internal inflation chamber of pod assembly 50.

In the embodiment shown, pod assembly 50 further includes at least one partition 70 for dividing internal cargo area 58 into a forward cargo area compartment 58a and an aft cargo area compartment 58b. As shown, an outer periphery of partition 70 is selectively attachable to and detachable from an inner periphery of forward exoskeleton portion 52 by a partition coupling mechanism in the form of a partition zipper 72. Partition zipper 72 may be configured to provide a fluid-tight seal between partition 70 and forward exoskeleton portion 52 such that forward cargo area compartment 58a may be fluidly isolated from aft cargo area compartment 58b when partition 70 is attached to forward exoskeleton portion 52. Partition 70 may include a flat panel of the same material as forward and aft exoskeleton portions 52, 54. In some versions, partition 70 may include a pocket defining an internal inflation chamber (not shown) for receiving an inflation fluid such as air or nitrogen to enable partition 70 to transition between inflated and deflated states. Such a configuration may assist with providing structural stability to pod assembly 50. In any event, partition 70 may allow cargo to be organized in a desired manner among forward and aft cargo area compartments 58a, 58b, such as for positioning a center of gravity of the cargo at a desired location within internal cargo area 58. While a single partition 70 is shown attached to forward exoskeleton portion 52, it will be appreciated that any suitable number of partitions 70 may be attached to any one or more of forward exoskeleton portion 52, aft exoskeleton portion 54, and/or intermediate frame portion 56. Such partitions 70 may each be selectively attachable and detachable to enable customizable reconfiguring of the number, size, shape, and/or position of cargo area compartments 58a, 58b. While partition zipper 72 is shown in the present version, it will be appreciated that any other suitable types of coupling mechanisms may be used to selectively attach partition 70 to any of exoskeleton portions 52, 54 or intermediate frame portion 56, such as a hook-and-loop fastener (e.g., Velcro).

As shown, intermediate frame portion 56 includes an opposed pair of attachment devices in the form of hooks or eyelets 74 for selectively engaging respective receiving assemblies 51 of wings 14, 16 to thereby removably couple pod assembly 50 to airframe 12. In this regard, eyelets 74 of the present version are arranged on opposed upper and lower surfaces of intermediate frame portion 56. Alternatively, eyelets 74 may be arranged on opposed lateral side surfaces of intermediate frame portion 56, such as for selectively engaging respective receiving assemblies (not shown) of pylons 18, 20, or may be arranged in any other suitable manner for securing pod assembly 50 to airframe 12. In some versions, intermediate frame portion 56 may be constructed of a substantially rigid material, such as metal, such that intermediate frame portion 56 is relatively rigid compared to forward and aft exoskeleton portions 52, 54. For example, intermediate frame portion 56 may neither expand nor contract during inflation or deflation of pod assembly 50. In this manner, intermediate frame portion 56 may assist with providing structural stability to pod assembly 50. More particularly, intermediate frame portion 56 may provide improved stability to pod assembly 50 at and/or near eyelets 74 for assisting with transferring load from pod assembly 50 to airframe 12.

Inflation of pod assembly 50 may be performed at any suitable time, such as during assembly of pod assembly 50, prior to loading cargo into pod assembly 50, and/or after loading cargo into pod assembly 50. In some versions, forward and aft exoskeleton portions 52, 54 may be sufficiently rigid to substantially retain their expanded states once inflated such that subsequent full or partial uncoupling of either exoskeleton portion 52, 54 from intermediate frame portion 56 may be performed (e.g., to access internal cargo area 58 for loading or unloading cargo), thereby placing internal cargo area 58 in fluid communication with the external environment, without causing deflation of pod assembly 50.

In addition to providing internal cargo area 58 for facilitating transportation of cargo, pod assembly 50 may serve as an aerodynamic fairing for aircraft 10 via its aerodynamic exterior shape. In some versions, pod assembly 50 may also provide aircraft 10 with impact protection by acting as a buffer between airframe 12 and surrounding objects. Pod assembly 50 may also provide the cargo contained therein with impact protection by acting as a buffer between such cargo and surrounding objects (e.g., airframe 12, ground, a body of water, etc.). Moreover, pod assembly 50 may operate as a flotation device for aircraft 10 and/or for cargo contained within pod assembly 50. In this regard, pod assembly 50 may be capable of floating atop water while containing cargo, at least when pod assembly 50 is in the inflated state. Thus, pod assembly 50 may be loaded with cargo and subsequently jettisoned from aircraft 10 during a flight operation over a body of water and, rather than sinking down into the body of water, pod assembly 50 may float atop the body of water to allow relatively simple retrieval of both the pod assembly 50 and the cargo contained therein from the body of water.

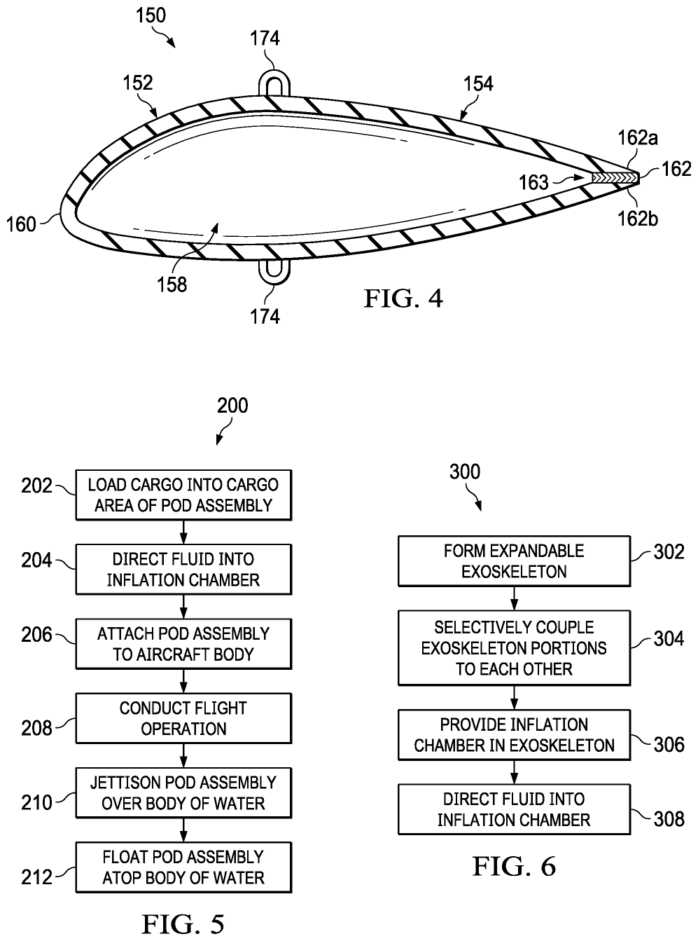

Referring now to FIG. 4, an alternative pod assembly 150 similar to pod assembly 50 except as otherwise described herein includes a generally bulbous forward exoskeleton portion 152 and a generally tapered aft exoskeleton portion 154 integrally formed together as a unitary piece to define an internal cargo area 158. As shown, forward and aft exoskeleton portions 152, 154 provide pod assembly 150 with an aerodynamic exterior shape and define leading and trailing edges 160, 162 respectively, of pod assembly 150. In the present version, trailing edge 162 is bifurcated such that trailing edge 162 includes upper and lower trailing edge portions 162a, 162b selectively attachable to and detachable from each other by a trailing edge coupling mechanism in the form of a trailing edge zipper 163. Thus, trailing edge zipper 163 may permit selective attaching of trailing edge portions 162a, 162b to each other to enclose internal cargo area 158, as well as selective detaching (e.g., full or partial detaching) of trailing edge portions 162a, 162b from each other to permit access to internal cargo area 158, such as for loading cargo thereinto or unloading cargo therefrom. In some versions, trailing edge zipper 163 may be configured to provide a fluid-tight (e.g., airtight and/or watertight) seal between trailing edge portions 162a, 162b such that internal cargo area 158 may be fluidly isolated from an external environment surrounding pod assembly 150 when trailing edge portions are attached to each other. While trailing edge zipper 163 is shown in the present version, it will be appreciated that any other suitable types of coupling mechanisms may be used to selectively attach upper and lower trailing edge portions 162a, 162b to each other, such as a hook-and-loop fastener (e.g., Velcro).

In some versions, pod assembly 150 may be inflatable in a manner similar to that described above with respect to pod assembly 50 to enable forward and aft exoskeleton portions 152, 154 to transition between expanded and contracted states in response to fluid such as air or nitrogen being introduced to or removed from internal cargo area 158. For example, fluid may be introduced to internal cargo area 158 to expand forward and aft exoskeleton portions 152, 154 to define the illustrated inflated state of pod assembly 150, and fluid may be removed from internal cargo area 158 to contract forward and aft exoskeleton portions 152, 154 to define a deflated state (not shown) of pod assembly 150. In some versions, at least one fluid port (not shown) may extend through at least one of forward exoskeleton portion 152 and/or aft exoskeleton portion 154 to facilitate transfer of fluid into and out of internal cargo area 158. In addition or alternatively, one or both exoskeleton portions 152, 154 may include at least one pocket defining an internal inflation chamber (not shown) fluidly isolated from internal cargo area 158. While not shown, pod assembly 150 may further include at least one partition 70 for dividing internal cargo area 158 into a plurality of cargo area compartments.

As shown, forward exoskeleton portion 152 includes an opposed pair of attachment devices in the form of hooks or eyelets 174 for selectively engaging respective receiving assemblies 51 of wings 14, 16 to thereby removably couple pod assembly 150 to airframe 12. In this regard, eyelets 174 of the present version are arranged on opposed upper and lower surfaces of forward exoskeleton portion 152. Alternatively, eyelets 174 may be arranged on opposed lateral side surfaces of forward exoskeleton portion 152, such as for selectively engaging respective receiving assemblies (not shown) of pylons 18, 20, or may be arranged in any other suitable manner for securing pod assembly 150 to airframe 12. In some versions, eyelets 174 may be constructed of a plastic material, and may be molded into forward exoskeleton portion 152 such that eyelets 174 are directly embedded therein.

Referring now to FIG. 5, a method 200 of transporting cargo begins with step 202, at which cargo is loaded into an internal cargo area 58, 158 of an inflatable pod assembly, such as either pod assembly 50, 150. After step 202, method 200 proceeds to step 204, at which an inflation fluid is directed into at least one internal inflation chamber 58, 68, 69, 158 of pod assembly 50, 150 to transition pod assembly 50, 150 from a deflated state to an inflated state. In some versions, step 204 may be performed during or prior to step 202. In any event, method 200 then proceeds to step 206, at which pod assembly 50, 150 is attached to an aircraft body of an aircraft, such as aircraft 10. In some versions, step 206 may be performed during or prior to one or both of steps 202, 204. In any event, method 200 then proceeds to step 208, at which a flight operation is conducted via the aircraft 10 while the inflatable pod assembly 50, 150 is attached to the aircraft body and in the inflated state. In the illustrated version, method 200 then proceeds to step 210, at which the inflatable pod assembly 50, 150 is jettisoned from the aircraft body over a body of water, and further proceeds to step 212, at which the inflatable pod assembly 50, 150 is floated atop the body of water via the inflation fluid within the internal inflation chamber 58, 68, 69, 158 of the inflatable pod assembly 50, 150.

Referring now to FIG. 6, a method 300 of manufacturing an inflatable pod assembly 50, 150 begins with step 302, at which an expandable exoskeleton is formed, which may include forming exoskeleton portions 52, 54 separately from a flexible, semi-rigid material or forming exoskeleton portions 152, 154 together from a flexible, semi-rigid material. Method 300 proceeds from step 302 to step 304, at which portions of the expandable exoskeleton are selectively coupled to each other, such as to enclose an internal cargo area 58, 158, which may include operatively coupling exoskeleton portions 52, 54 to each other via intermediate frame portion 56, or attaching trailing edge portions 162a, 162b to each other. In any event, method 300 proceeds to step 306, at which at least one inflation chamber 58, 68, 69, 158 is provided within the exoskeleton, which may include providing internal cargo area 58, 158 and/or pockets 68, 69. In some versions, step 306 may be performed during or prior to one or both of steps 302, 304. In the illustrated version, method 300 then proceeds to step 308, at which an inflation fluid is directed into at least one internal inflation chamber 58, 68, 69, 158 of pod assembly 50, 150 to transition pod assembly 50, 150 from a deflated state to an inflated state.

While pod assemblies 50, 150 have been described for use with aircraft 10, it will be appreciated that pod assemblies 50, 150 may be used with any suitable type of aircraft, such as a helicopter. For example, pod assemblies 50, 150 may be selectively attachable to corresponding receiving assemblies provided on an underside of such a helicopter via eyelets 74, 174 or any other suitable attachment devices.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An inflatable pod assembly for an aircraft, the inflatable pod assembly comprising:
(a) an expandable exoskeleton, wherein the expandable exoskeleton defines a leading edge and a trailing edge of the inflatable pod assembly, wherein the expandable exoskeleton includes first and second portions selectively attachable to each other;
(b) an internal cargo area configured to receive cargo, wherein the first and second portions are configured to selectively enclose the internal cargo area when the first and second portions are attached to each other; and
(c) an internal inflation chamber configured to selectively receive an inflation fluid for expanding the exoskeleton to thereby transition the inflatable pod assembly from a deflated state to an inflated state.

2. The inflatable pod assembly of claim 1, wherein the internal inflation chamber is defined by the internal cargo area.

3. The inflatable pod assembly of claim 1, wherein the internal inflation chamber is defined by a pocket fluidly isolated from the internal cargo area.

4. The inflatable pod assembly of claim 1, further comprising at least one coupling mechanism configured to selectively attach the first and second portions of the expandable exoskeleton to each other to thereby enclose the internal cargo area.

5. The inflatable pod assembly of claim 4, wherein the at least one coupling mechanism is configured to provide a fluid-tight seal between the first and second portions of the expandable exoskeleton when the first and second portions are attached to each other.

6. The inflatable pod assembly of claim 4, wherein the at least one coupling mechanism includes a zipper.

7. The inflatable pod assembly of claim 1, wherein the expandable exoskeleton comprises a flexible material.

8. The inflatable pod assembly of claim 7, wherein the flexible material includes nylon.

9. The inflatable pod assembly of claim 1, further comprising at least one partition positioned in the internal cargo area and selectively attachable to the expandable exoskeleton for dividing the internal cargo area into a plurality of cargo area compartments.

10. The inflatable pod assembly of claim 1, further comprising at least one attachment device configured to couple to a receiving assembly of the aircraft.

11. The inflatable pod assembly of claim 1, wherein the first portion includes a forward exoskeleton portion, wherein the second portion includes an aft exoskeleton portion separable from the forward exoskeleton portion.

12. The inflatable pod assembly of claim 11, further comprising an intermediate frame portion, wherein the at least one coupling mechanism includes a forward coupling mechanism and an aft coupling mechanism configured to selectively attach the forward and aft exoskeleton portions to the intermediate frame portion, respectively, for operatively attaching the forward and aft exoskeleton portions to each other.

13. The inflatable pod assembly of claim 12, wherein the intermediate frame portion comprises a rigid material.

14. The inflatable pod assembly of claim 1, wherein the trailing edge is bifurcated, wherein the first portion includes an upper trailing edge portion, wherein the second portion includes a lower trailing edge portion.

15. The inflatable pod assembly of claim 14, wherein the expandable exoskeleton includes a forward exoskeleton portion and an aft exoskeleton portion integrally formed together as a unitary piece.

16. An aircraft comprising:
(a) an aircraft body; and
(b) an inflatable pod assembly selectively attached to the aircraft body, wherein the inflatable pod assembly includes:
(i) an expandable exoskeleton, and
(ii) an internal cargo area defined within the expandable exoskeleton, wherein the internal cargo area is configured to receive cargo.

17. The aircraft of claim 16, wherein the inflatable pod assembly further includes an internal inflation chamber configured to selectively receive an inflation fluid for expanding the exoskeleton to thereby transition the inflatable pod assembly from a deflated state to an inflated state.

18. The aircraft of claim 16, wherein the inflatable pod assembly is selectively attached to an exterior of the aircraft body.

19. A method of transporting cargo, the method comprising:
(a) loading the cargo into an internal cargo area of an inflatable pod assembly;
(b) directing an inflation fluid into an internal inflation chamber of the inflatable pod assembly to transition the inflatable pod assembly from a deflated state to an inflated state;
(c) selectively attaching the inflatable pod assembly to an aircraft body of an aircraft; and
(d) conducting a flight operation via the aircraft while the inflatable pod assembly is selectively attached to the aircraft body and in the inflated state.

20. The method of claim 19, further comprising:
(a) jettisoning the inflatable pod assembly from the aircraft body over a body of water; and
(b) floating the inflatable pod assembly atop the body of water via the inflation fluid within the internal inflation chamber of the inflatable pod assembly.
